(19) United States
(12) Patent Application Publication
(10) Pub. No.: US 2026/0358754 A1
(43) Pub. Date: Nov. 12, 2026

(54) OPTICAL MANUFACTURE OF ON-CHIP NARROW BAND FILTERS WITH TAILORED SPATIO-SPECTRAL CHARACTERISTICS

(71) Applicants: Massachusetts Institute of Technology, Cambridge, MA (US); Samsung Electronics Co., Ltd., Suwon-si (KR)

(72) Inventors: Mathias KOLLE, Hull, MA (US); Benjamin MILLER, Cambridge, MA (US); Youngzoon YOON, Gwacheon (KR); Radwanul Hasan SIDDIQUE, Monrovia, CA (US)

(21) Appl. No.: 19/444,175

(22) Filed: Jan. 8, 2026

Related U.S. Application Data
(60) Provisional application No. 63/801,777, filed on May 7, 2025.

(51) Int. Cl. G03H 1/04

(52) U.S. Cl. CPC G03H 1/0402; G03H 1/0443

(57) ABSTRACT

Provided are systems, methods, and apparatuses for optical manufacture of on-chip narrow band filters with tailored spatio-spectral characteristics. In one or more examples, the systems, devices, and methods include fabricating a holographic optical filter of a device, which includes positioning a photosensitive material of the device between a pixel array of the device and an imaging system comprising a light source and a lens; and exposing the photosensitive material to an interference pattern formed by incident spatially incoherent light from the light source and a reflection of the incident spatially incoherent light, where the interference pattern forms filter structures that encode gonio-spectral filtering characteristics matched to a light field and aberration properties of the imaging system.

### CROSS-REFERENCE TO RELATED APPLICATIONS

This application claims the benefit of U.S. Provisional Patent Application Serial No. 63/801,777, filed May 7, 2025, which is incorporated by reference herein for all purposes.

### TECHNICAL FIELD

The subject matter disclosed relates to imagine systems. In particular, the subject matter disclosed relates to optical manufacture of on-chip narrow band filters with tailored spatio-spectral characteristics.

### SUMMARY

Imaging devices used in consumer electronics, industrial metrology, and defense applications capture information by projecting light that originates from different directions in a scene onto an optical detector chip (e.g., complementary metal-oxide-semiconductor (CMOS) chip, charge coupled device (CCD) chip). Spectral filtering is a signal processing technique that separates or modifies data by manipulating its frequency components. A signal, whether a sound file, image, or other data, is transformed from its original form into the frequency domain, where it is represented by various frequencies or wavelengths. By applying different filter functions, specific frequencies can be reduced or eliminated (like with low-pass or high-pass filters), or selectively enhanced (using a band-pass filter), effectively removing noise, isolating certain features, or shaping the overall characteristics of the signal. This process is used in various fields, such as optical filter engineering, medical diagnostics, remote sensing, and graph neural networks, to improve the quality of data and extract specific information.

Spectral filtering of incident light prior to capture at a detector may be desired in different application scenarios. Designing filters with tailored reflection/transmission characteristics and angle-independent or tailored angular filtering characteristics are ongoing challenges. The systems and methods described herein may be based on spectrally selective filters positioned before an image-forming detector. Optical filter design to permit tailored filtering and isolation of desired optical signals, as well as suppression of unwanted noise, can improve imaging, spectroscopy, and metrology in consumer devices and industrial inspection environments. A filter may be applied in conjunction with a detector that includes an array of pixels. Based on the systems and methods described herein, a filter may be matched to the detector with respect to the spectral transmission characteristics desired for the application-specific sources and objects in front of the imaging system that contribute to the spectral-spatial nature of the detected light. The optical filters described herein may be relatively easy and cost-efficient to integrate with the detector fabrication, thus reducing system complexity and system costs.

In various embodiments, the systems and methods described herein include systems, methods, and apparatuses for optical manufacture of on-chip narrow band filters with tailored spatio-spectral characteristics. In some aspects, the techniques described herein relate to a method of fabricating a holographic optical filter of a device, the method including: positioning a photosensitive material of the device between a pixel array of the device and an imaging system including a light source and a lens; and exposing the photosensitive material to an interference pattern formed by incident spatially incoherent light from the light source and a reflection of the incident spatially incoherent light, wherein the interference pattern forms filter structures that encode gonio-spectral filtering characteristics matched to a light field and aberration properties of the imaging system.

In some aspects, the techniques described herein relate to a method, wherein: the photosensitive material is positioned directly on the pixel array, and the photosensitive material includes a holographic thin film. In some aspects, the techniques described herein relate to a method, wherein the photosensitive material is positioned to form a gap between the photosensitive material and the pixel array.

In some aspects, the techniques described herein relate to a method, wherein the gap includes at least one of a vacuum, a polymer, liquid crystal, a fluid, a gel, glass, air, or any type of gas. In some aspects, the techniques described herein relate to a method, wherein: the filter structures are formed in accordance with an expected illumination environment of the device, and a filter structure of the filter structures is associated with a pixel, a portion of a pixel, or group of pixels in the pixel array.

In some aspects, the techniques described herein relate to a method, further including providing a back reflector adjacent to the pixel array to facilitate formation of standing wave interference patterns in the photosensitive material during filter fabrication, wherein a pixel spacing of the pixel array is based on imaging optics of the device and a target wavelength of the light source.

In some aspects, the techniques described herein relate to a method, further including forming the filter structures in the photosensitive material by focusing multiple beams of light from the light source on selected areas of the photosensitive material to modify respective refractive indices in the selected areas.

In some aspects, the techniques described herein relate to a method, further including tuning a bandwidth of a filter structure of the holographic optical filter based on configuring the interference pattern to control a refractive index contrast in adjacent portions of the photosensitive material.

In some aspects, the techniques described herein relate to a method, wherein the photosensitive material includes a polymeric film or liquid crystal material, and wherein exposure to the interference pattern modifies a refractive index of respective portions of the photosensitive material to form the filter structures.

In some aspects, the techniques described herein relate to a method, further including configuring the holographic optical filter to provide angle-independent spectral filtering for incident light over a field of view of at least 35 degrees.

In some aspects, the techniques described herein relate to a method, further including directing spatially incoherent light through the lens configured to project a desired light field onto the photosensitive material, wherein the photosensitive material is exposed to a plurality of spatially incoherent light sources from the light source, the spatially incoherent light sources having spectral characteristics matched to desired filter bands of the respective filter structures to form spatially and spectrally tailored filter structures.

In some aspects, the techniques described herein relate to a system for fabricating a holographic optical filter of a device, including: a light source and imaging optics of an imaging system; and a pixel array and a photosensitive material of the device, the photosensitive material positioned between the pixel array and the imaging system, wherein: filter structures are formed in the photosensitive material by exposure to an interference pattern generated by incident spatially incoherent light from the light source and a reflection of the incident spatially incoherent light off the pixel array, and the filter structures encode gonio-spectral filtering characteristics matched to a light field and aberration properties of the imaging system.

In some aspects, the techniques described herein relate to a system, wherein the photosensitive material is positioned directly on the pixel array and includes a holographic thin film. In some aspects, the techniques described herein relate to a system, wherein the photosensitive material is positioned to form a gap between the photosensitive material and the pixel array.

In some aspects, the techniques described herein relate to a system, wherein the gap includes at least one of a vacuum, a polymer, liquid crystal, a fluid, a gel, glass, air, or any type of gas. In some aspects, the techniques described herein relate to a system, wherein the filter structures are formed in accordance with an expected illumination environment of the device, and a filter structure of the filter structures is associated with a pixel, a portion of a pixel, or a group of pixels in the pixel array.

In some aspects, the techniques described herein relate to a system, further including a back reflector of the device adjacent to the pixel array, the back reflector configured to facilitate formation of standing wave interference patterns in the photosensitive material during fabrication of the filter structures.

In some aspects, the techniques described herein relate to a device including: a pixel array; and a photosensitive material positioned adjacent to the pixel array, wherein: the photosensitive material includes filter structures that are formed based on the photosensitive material being exposed to an interference pattern generated by incident spatially incoherent light from a light source and a reflection of the incident spatially incoherent light off the pixel array, and the filter structures encode gonio-spectral filtering characteristics matched to a light field and aberration properties of the light source and imaging optics.

In some aspects, the techniques described herein relate to a device, wherein the photosensitive material is positioned directly on the pixel array and includes a holographic thin film. In some aspects, the techniques described herein relate to a device, wherein the photosensitive material is positioned to form a gap between the photosensitive material and the pixel array.

The systems and methods described herein include multiple benefits and advantages. The systems and methods may be based on forming structures (e.g., optical structures) in a holographic film. The structures of the holographic film provide a relatively narrow band optical filter with narrow band colors or narrow frequency filters. The structures in the holographic film mimic a curved or spatio-controlled optical filter, or a stack of curved lenses. Because the structures are curved or spatio controlled, the holographic film provides a better angular response. As a result, the frequency of the light (e.g., red light) does not change at various viewing angles because the structures emit a cleaner signal. Accordingly, the holographic is angle independent and provides higher color purity at a relatively broad field of view. The systems and methods provide a relatively easy-to-manufacture by presenting the light-field characteristics via the device optics to the filter blank, setting up an interference pattern between the incident field and the field reflected by the detector array that generates the appropriate filter characteristics in the holographic film (e.g., on top of respective pixels). The systems and methods enable real time observation of filter formation based on reading out detector response.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates an example system in accordance with one or more implementations as described herein.

FIG. 3 illustrates an example system in accordance with one or more implementations as described herein.

FIG. 4 illustrates an example system in accordance with one or more implementations as described herein.

FIG. 5 illustrates an example optical filter in accordance with one or more implementations as described herein.

FIG. 6 illustrates an example graph in accordance with one or more implementations as described herein.

FIG. 7 illustrates an example interference pattern in accordance with one or more implementations as described herein.

FIG. 8 depicts a flow diagram illustrating an example method associated with the disclosed systems, in accordance with example implementations described herein.

FIG. 9 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure are described with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media includes all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random-access memory (CBRAM), phase-change random-access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random-access memory (FJG RAM), Millipede memory, racetrack memory, and/or the like.

In one embodiment, a volatile computer-readable storage medium may include random-access memory (RAM), dynamic random-access memory (DRAM), static random-access memory (SRAM), fast page mode dynamic random-access memory (FPM DRAM), extended data-out dynamic random-access memory (EDO DRAM), synchronous dynamic random-access memory (SDRAM), double data rate synchronous dynamic random-access memory (DDR SDRAM), double data rate type two synchronous dynamic random-access memory (DDR2 SDRAM), double data rate type three synchronous dynamic random-access memory (DDR3 SDRAM), Rambus dynamic random-access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random-access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of a hardware embodiment, a computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, a hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some examples, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures(including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some embodiments and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The provided description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Data processing may include data buffering, aligning incoming data from multiple communication lanes, forward error correction (FEC), etc. For example, data may be received by an analog front end (AFE), which can prepare the incoming data for digital processing. The digital portion of the transceivers (e.g., digital signal processor (DSP)) may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution, and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, SoC, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

An optical filter may be associated with a pixel (e.g., one or more pixels). With some systems, a pixel may be associated with an optical filter that includes a stack of curved lenses, multiple layers of curved lenses, where each subsequent lens becomes more curved the closer the given lens gets to the pixel. The stack of curved lenses provides angle insensitivity (e.g., relatively high signal quality over a relatively large range of angles). But stacked lenses take up a relatively large space. Some approaches to optical filter manufacture rely on binary vacuum deposited combinations of metal oxides, metal sulfides, and polymers. Spatial structuring of the filter and cost-efficient in-situ integration with the detector chip are challenging to achieve with these approaches. For instance, interference filters built from metal oxide- or polymer-based planar Bragg gratings have significant angle dependence, which severely complicates the generation of persistent spectrally narrow stop- and pass-bands and/or the rational design of tailored gonio-spectral filter characteristics. Such filters are also not easily matched to characteristics of the imaging system that may be varying from device to device (pixel-by-pixel aberration effects, etc.). Such filters do not offer the ability to tailor a given filter’s gonio-spectral reflection/transmission characteristics in-situ and in total device alignment.

The systems and methods described herein aim to solve problems associated with optical filters for optical sensors. With some systems, the color filters in the optical sensors or cameras may be chemical sensors and/or filters. These optical filters may use absorptive-based phenomena. These optical filters may be relatively thick, resulting in their absorption profile having a relatively broad bandwidth. For example, some red green blue (RGB) filters used in cameras may have a relatively broad absorption profile.

The systems and methods described herein provide narrow optical filters with a relatively narrow reflection band or relatively narrow absorption band (e.g., a narrow notch in the transmission window). Some systems may use thin films to provide narrow filters, but the thin film narrow filters of some systems can have poor performance at relatively high angles of incidence (e.g., relatively low signal quality at high angles).

The systems and methods described herein may provide spatially tailored filtering (e.g., gonio-spectral narrow filters), where the narrow filters not only have spectral enhancing structures, but gonio structures as well that provide relatively high signal quality over a relatively large range of angles, including relatively high angles.

The systems and methods described herein may include fabricating an optical filter holographically. A light source may be configured to create an interference pattern in a light-sensitive material (e.g., holographic film). The systems and methods described herein may include forming structures in a thin film that mimics the stack of curved lenses, where the thin film formed with the structures may be referred to as a holographic film. In some cases, a holographic film means it interacts with light. A holographic film can be a material that interacts with a light source. For example, the light source changes the refractive index of the holographic film based on the intensity of the light source. The greater the intensity of the light source, the greater can be the change in refractive index in the holographic film. The systems and methods described herein may include focusing a light source on specific areas of a holographic film to modify the refractive index of the holographic film in those specific areas (e.g., areas associated with a pixel, a portion of a pixel, and/or a group of pixels). Based on these systems and methods, structures may be formed in a holographic film, where the formed structures provide angle insensitivity to incoming light (e.g., for sensor pixels) or outgoing light (e.g., for display pixels).

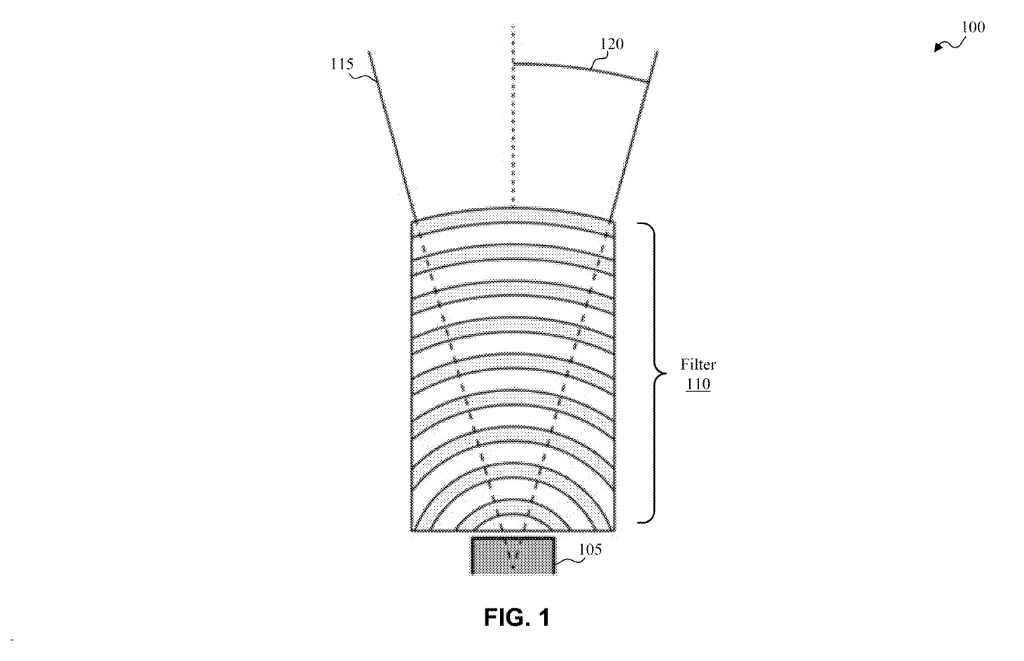

FIG. 1 illustrates an example system 100 in accordance with one or more implementations as described herein.

As shown, system 100 includes pixel 105, filter 110, and cone of light 115. Pixel 105 may be part of an array of pixels (e.g., array of sensor pixels, array of display pixels). Filter 110 may be a concentric optical filter or gonio-spectral filter. As shown, filter 110 may be configured to match acceptance angle 120 in relation to cone of light 115.

In the illustrated example, filter 110 may focus incoming light (e.g., cone of light 115) onto a photosensitive area of pixel 105. As shown, filter 110 may include multiple layers of increasingly concentric or increasingly curved lenses the closer the incident light gets to pixel 105.

As shown, cone of light 115 may be defined by acceptance angle 120. Acceptance angle 120 may describe the maximum half-angle of cone of light 115. The full range of cone of light 115 may be referenced as theta, where acceptance angle 120 is half of theta. In some cases, the larger the acceptance angle, the larger the diameter arc of filter 110. In some cases, cone of light 115 may be based on acceptance angle 120. Cone of light 115 may be based on an acceptance cone, or a three-dimensional volume of shaped like a cone, within which light rays can reach pixel 105 through filter 110, whereas light rays outside this cone may not reach pixel 105.

In some examples, an acceptance angle may be decreased for a relatively small pixel or for a pixel where the pixel spacing in the array of pixels decreases. However, as acceptance angle 120 or cone of light 115 decreases, the spatial resolution for the affected pixel decreases. Thus, there can be trade-offs between angle insensitivity and spectral insensitivity. Trade-offs can occur based on the size of the structures. For example, with relatively small pixels, the arc shape may be configured to be smaller to match the smaller pixel. But when the arc is smaller, then the incidence angle is reduced, where the trade-off is less sensitivity. Some devices may have relatively high angle sensitivity (e.g., worse performance with higher angles), where the spectra have some frequency shifts due to viewing angles and/or temperature (e.g., temperature within the device and/or around the device).

In some cases, light fields in an image-forming device in front of a light detector (e.g., system 100) may be composed of converging spherical waves. A filter that has an angle-independent spectral pass- or stop-band structure (e.g., filter 110) may be matched in its morphology to this characteristic of the incident light field. In some cases, filter 110 may be based on a Bragg stack (e.g., a multilayer arrangement of alternating high and low refractive indices). Filter 110 may be configured for a single pixel on a detector (e.g., pixel 105), where the morphology of filter 110 may include hemispherical layers centered on pixel 105.

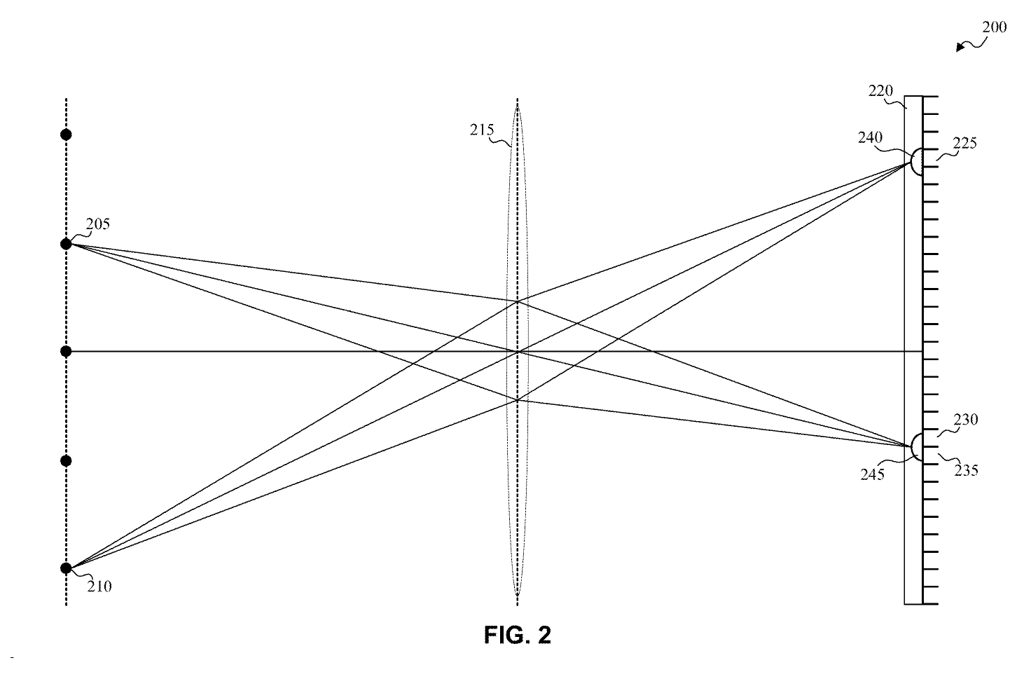

FIG. 2 illustrates an example system 200 in accordance with one or more implementations as described herein. In some configurations, one or more aspects of system 200 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.). System 200 may illustrate holographic on-chip generation of narrow-stopband angle-independent optical filters.

FIG. 2 depicts a system 200. As shown, system 200 may include a light grid (e.g., light source 205, light source 210), imaging optics 215, holographic film 220, and an array of pixels that include pixel 225, pixel 230, and pixel 235. As shown, imaging optics 215 may direct incoherent light from light source 205 to form structure 240 in holographic film 220. Similarly, imaging optics 215 may direct incoherent light from light source 210 to form structure 245 in holographic film 220.

FIG. 2 depicts a side-view of system 200. The light grid may include a grid or an array of points of incoherent light (e.g., rows of incoherent light points and columns of incoherent light points) that include light source 205 (e.g., a first incoherent light point) and light source 210 (e.g., a second incoherent light point). Similarly, the pixel array may include rows of pixels and columns of pixels. Accordingly, respective points of incoherent light in the array of incoherent light points may be focused on respective pixels in the pixel array.

A holographic film such as holographic film 220 may be configured for a device, where the device may be any camera device, any photosensor device, any display device, etc. The device may include any display device (e.g., mobile device, laptop screen, tablet screen, television screen, etc.). In some cases, the device may be a hyperspectral camera, a spectroscopy camera, or a camera that can detect spectra or may be used in a spectroscopy application. Holographic film 220 and the depicted pixel array (e.g., pixel 225, pixel 230, and pixel 235) may be part of such a device.

The systems and methods described herein may be based on an optical lithography process. The optical lithography process may be considered similar to film photography, where light from the lens forms structures in the photographic film. Similarly, light may be used to form structures in a holographic film. Holographic film 220 may be implemented similar to a photo mask in the optical lithography process.

The depicted light grid (e.g., light source 205, light source 210) and imaging optics 215 may be used to form structures of the device (e.g., holographic film 220), but the light grid and imaging optics 215 may not be part of the device. Light source 205 and light source 210 may emit spatially incoherent light, where the light grid may emit multiple point sources of spatially incoherent light (e.g., simultaneously). Additionally, or alternatively, system 200 may implement homogenous full-field spatially incoherent illumination to form structures in holographic film 220. Accordingly, a light source may be used to form structures in holographic film 220, where a given structure may be formed for an individual pixel (e.g., pixel 225, pixel 230, pixel 235), a portion of a pixel, or multiple pixels. In some cases, the light source (e.g., light source 205, light source 210) may have spectral characteristics matched to the desired filter bands of the respective structures formed in holographic film 220. In some cases, a given light source may be configured to emit light at a wavelength from 13.5 nanometers to hundreds of nanometers (e.g., up to 950 nanometers).

As shown, holographic film 220 may be positioned on (e.g., directly on) an array of pixels. Holographic film 220 can be any photosensitive material. Holographic film 220 can be a polymeric film, made of one or more polymers, or any photosensitive material. In some cases, holographic film 220 can include liquid crystals. Holographic film 220 can be based on halide-based chemistries for holographic filter manufacturing. Based on the systems and methods described herein, holographic optical manufacture of filters provides access to filter structures in 1D, 2D, 3D and device-respective (e.g., device-specific) gonio-spectral properties.

In some cases, the structures formed in holographic film 220 may be based on a light profile. The light from the optical lithography process forms structures or structures in holographic film 220, and these structures replicate how the light profile is projected and reflected upon the film. The light profile may be based on a position of the respective light sources (e.g., light source 205, light source 210). For example, the light profile may be based on a grid of light sources, where the light profile is based on the position of the light sources across that grid. The light profile may also be based on imaging optics that direct the light sources to targeted areas of holographic film 220, where the targeted areas are associated with a pixel, a portion of a pixel, or a subset of pixels. Thus, the systems and methods described herein include replicating what the light field projects onto holographic film 220.

As shown, imaging optics 215 (e.g., a lens, incoherent lens) focuses the incoming light on a pixel area of holographic film 220. In some cases, imaging optics 215 may be an incoherent lens configured to focus incoherent light of the respective light sources. Incoherent light can include light with random, rapidly changing phase relationships between its constituent waves. The light used to form structures in holographic film 220 may include incoherent light. Incoherent beams can be Gaussian in nature, where the beam’s cross-sectional intensity profile (e.g., the spatial distribution of its brightness) follows a bell-shaped Gaussian curve, even though the light waves that make up the beam are not in a fixed phase relationship with each other.

As shown, imaging optics 215 may be contoured to direct incoming incoherent light to form structures in holographic film 220 (e.g., structure 240, structure 245). As shown, a structure formed in holographic film 220 may be an arc shaped structure that mimics a stack of curved lenses (e.g., mimics filter 110 of FIG. 1). Aspects of the structures formed in holographic film 220 (e.g., location, diameter, width, length, depth, shape, curvature, etc.) may be controlled based on the configuration of imaging optics 215 and the light sources. For example, the shape of the structures being curved or arc-shaped, such as structure 240 and structure 245, may be based on the configuration of imaging optics 215 and the respective light sources.

Holographic film 220 may have an initial refractive index (e.g., 1.3) before controlled points of light form respective structures in holographic film 220. In some cases, the pixel array may include a reflector to reflect the incoherent light. For example, a device of the systems and methods described herein may be configured with a pixel array (e.g., detection plane, sensor pixel array, display pixel array), a holographic film, and a back reflector. The incident light and reflected light may interact, producing a standing wave due to interference patterns in the incident light and reflected light. The standing waves may produce the structures in holographic film 220 (e.g., structure 240, structure 245) based on the incident light interfering with the reflected light, where the interference is configured to occur within holographic film 220. The standing wave pattern may include a pattern of constructive interference, destructive interference, constructive interference, etc. This pattern of constructive and destructive interference may have high intensity areas and low intensity areas. For example, the standing wave may include an alternating pattern of high intensity, low intensity, high intensity, etc.

In some cases, the high intensity portions of the standing wave may change the refractive index of holographic film 220. For example, portions of holographic film 220 may change to 1.4 based on high intensity portions of the standing wave, while other portions may remain 1.3 based on low intensity portions of the standing wave, resulting in a pattern of 1.3 then 1.4, 1.3, 1.4, 1.3, 1.4, and so on. These changes in the refractive index may mimic a stack of curved lenses (e.g., mimic filter 110).

The formation of structures in holographic film 220 may be based on incoherent light sources (e.g., light source 205, light source 210) with spectral characteristics, which may be based on a desired filter path. For example, for 940 nanometer spectral holographic film filters, the light source may have a wavelength of 940 nanometers of incoherent light.

With the optical lithography process, holographic film 220 may be similar or equivalent to a photo mask. However, with the optical lithography process, holographic film 220 is not being used to make something directly on top of silicon. Instead, holographic film 220 is kept as a film on top of the silicon of the pixel array. With the optical lithography process, structures are patterned on top of holographic film 220 based on the light. The optical lithography process may be done at the pixel level. For example, a first structure from a first light source may be for a first pixel, a second structure from a second light source may be for a second pixel, and so on, where the second structure may be different from the first structure. In some cases, multiple structures may be formed for one pixel. In some cases, one structure may be formed for multiple pixels. A structure of holographic film 220 may be from 5 nanometers in width to a few hundred microns in width.

The optical lithography process may form multiple structures in holographic film 220 based on projecting (e.g., in a single instance) multiple sources of light (e.g., multiple spatially incoherent light source) onto holographic film 220. For example, a first source of light may form a first structure, a second source of light different from the first source of light may form a second structure different from the first structure, and so on. Thus, the multiple sources of light may form a pattern based on the arrangement of the multiple sources of light in relation to holographic film 220.

Based on the systems and methods described herein, a filter (e.g., structure 240, structure 245) can be fabricated holographically using a light field (e.g., light source 205, light source 210) that represents the characteristic features expected in the filters application scenarios. The filter may be designed and produced holographically with any desirable gonio-spectral filtering characteristics, with bandwidths depending on the index contrast achievable in the holographic material. Each structure in holographic film 220 may be configured as a filter. A given filter may be matched to a light field and aberration characteristics intrinsic to the imaging system and detector, thus not contributing to additional distortions.

Based on the systems and methods described herein, a glass cover may be skipped or not used on the pixel array, which decreases fabrication costs. Instead, as depicted, a laminate film (e.g., holographic film 220) may be positioned on the pixel array. Based on the systems and methods described herein, an array of spatially incoherent point sources or a spatially incoherent area illumination that captures features of the expected illumination environment of the relevant application scenario may be implemented to form filter structures in holographic film 220.

Accordingly, the systems and methods described herein provide optical on-chip generation of spatio-spectrally tailored filtering structures matched to a device’s expected gonio-spectral light incidence conditions. The systems and methods described herein provide an on-chip narrow-reflection-band holographic filter design and manufacture fully matched to and accounting for imaging system and detector characteristics (e.g., aberrations and resolution constraints), where aberrations can be imperfections in an optical imaging system, like a lens or mirror of a system.

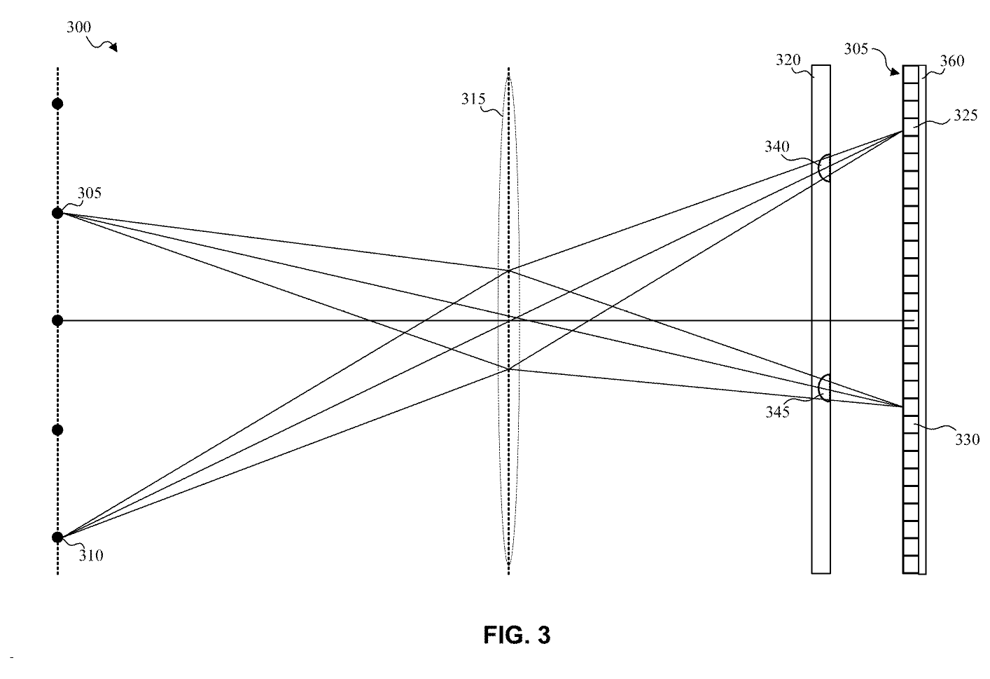

FIG. 3 illustrates an example system 300 in accordance with one or more implementations as described herein. In some configurations, one or more aspects of system 300 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.).

In the illustrated example, system 300 may include a light grid (e.g., light source 305, light source 310), imaging optics 315, holographic film 320, a pixel array that includes pixel 325, and pixel 330, and back reflector 360. As shown, imaging optics 315 may direct incoherent light from light source 305 to form structure 340 in holographic film 320. Similarly, imaging optics 315 may direct incoherent light from light source 310 to form structure 345 in holographic film 320.

As shown, holographic film 320 may be configured or positioned as a standoff filter. When the holographic film is not on the pixel array (e.g., not directly on a detection plate as with system 200), a substrate may be placed between the holographic film and the pixel array. Thus, system 300 may include a physical space between holographic film 320 and the pixel array that includes pixel 325 and pixel 330. When a gap is formed between the holographic film and pixel array, the distance between the holographic film and the pixel array may range from 100 nanometers to 100 millimeters.

The substrate between the holographic film and pixel array may include glass, air, gases other than air (e.g., noble gases), a vacuum, liquid, gel, oil, liquid crystals, photonic band-gap material, photonic crystals, etc. Back reflector 360 may include one or more structures of metal or any material that reflects light.

As shown, light from light source 305 may pass through imaging optics 315, which may focus the light towards pixel 325. As shown, light from light source 305 may pass through holographic film 320 from imaging optics 315 and light from light source 305 may reflect off back reflector 360 and pass back through holographic film 320. This incident light and reflected light may interfere in holographic film 320 to form structure 340, where structure 340 may be formed as an optical filter for pixel 325. Similarly, incident light and reflected from light source 310 may interfere in holographic film 320 to form structure 345, where structure 345 may be formed as an optical filter for pixel 330.

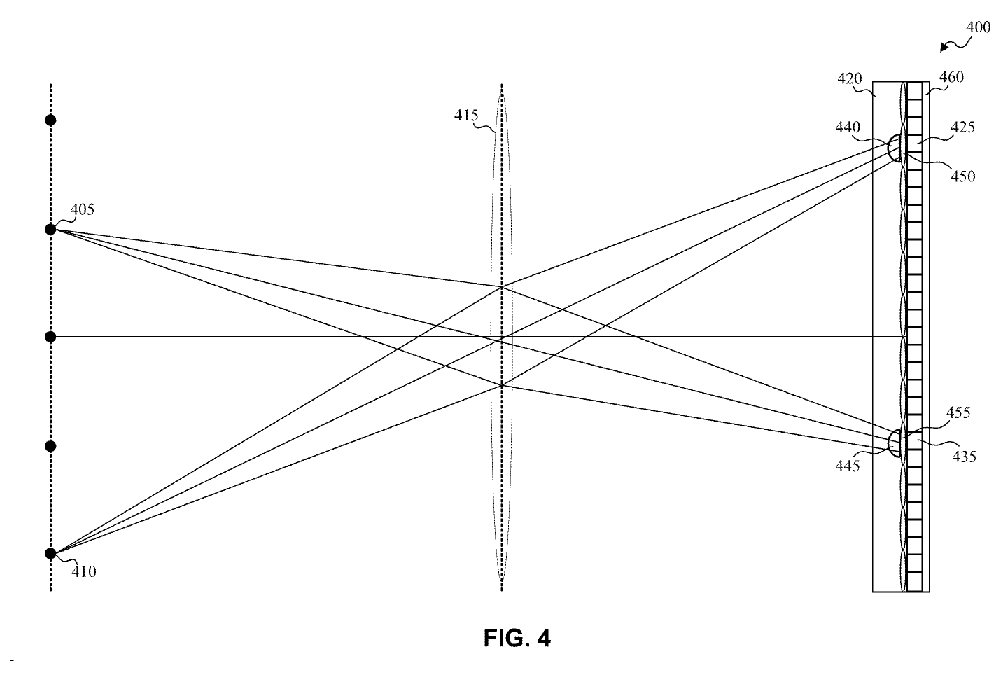

FIG. 4 illustrates an example system 400 in accordance with one or more implementations as described herein. In some configurations, one or more aspects of system 400 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.).

In the illustrated example, system 400 may include a light grid (e.g., light source 405, light source 410), imaging optics 415, holographic film 420, a pixel array that includes pixel 425 and pixel 435, a lenslet array that includes lenslet 450 and lenslet 455, and back reflector 460. As shown, imaging optics 415 may direct incoherent light from light source 405 to form structure 440 in holographic film 420. Similarly, imaging optics 415 may direct incoherent light from light source 410 to form structure 445 in holographic film 420.

As shown, system 400 may include a lenslet array that includes one or more lenslets (e.g., lenslet 450, lenslet 455, etc.). A lenslet array, also known as a microlens array, may include a two-dimensional grid of relatively small, individual lenses called lenslets. A given lenslet may be used to manipulate light precisely for various applications (e.g., for a pixel aligned with a lenslet). A lenslet array can focus, diffuse, or direct light, and may be used in fields such as 3D imaging, digital projectors, and optical sensors, where uniform illumination or improved light collection is sought. Back reflector 460 may include one or more structures of metal or any material that reflects light.

As shown, light from light source 405 may pass through imaging optics 415, which may focus the light towards pixel 425. As shown, light from light source 405 may pass through holographic film 420 from imaging optics 415 and light from light source 405 may reflect off back reflector 460 and pass back through holographic film 420. As shown, light from light source 405 may pass through lenslet 450, reflect off back reflector 460, pass through lenslet 450 and interfere with the incident light within holographic film 420 where structure 445 is formed. Accordingly, the incident light and reflected light may interfere in holographic film 420 to form structure 445, where structure 445 may be formed as an optical filter for pixel 435. Similarly, based at least in part on lenslet 455, incident light and reflected from light source 410 may interfere in holographic film 420 to form structure 440, where structure 440 may be formed as an optical filter for pixel 425.

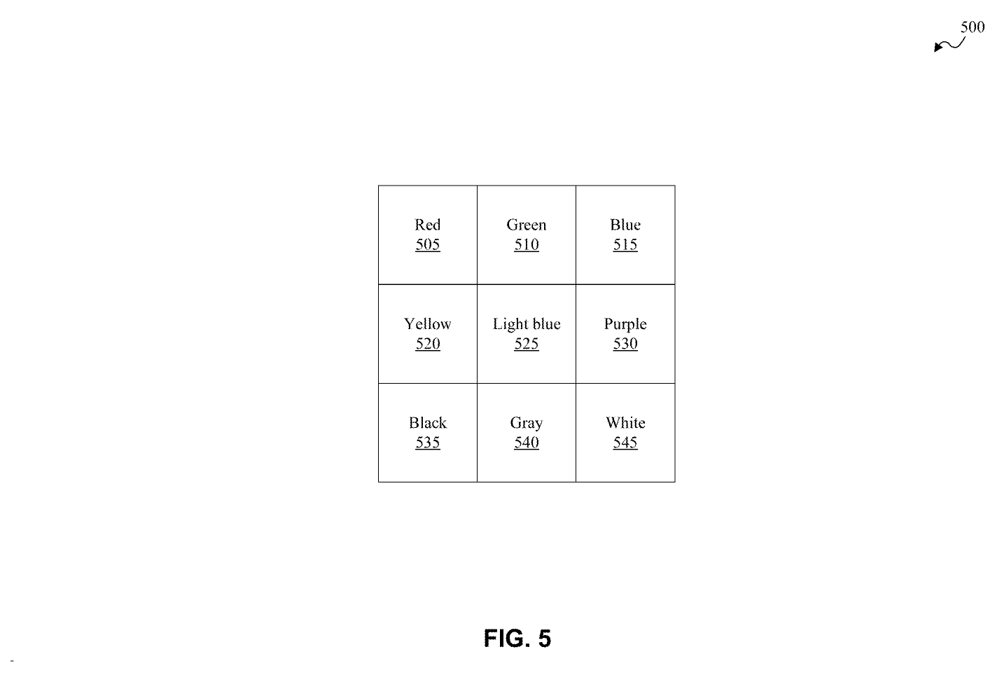

FIG. 5 illustrates an example optical filter 500 in accordance with one or more implementations as described herein. In some configurations, one or more aspects of optical filter 500 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.).

In the illustrated example, FIG. 5 depicts a pattern formed in optical filter 500. In some cases, optical filter 500 may be at least a portion of a holographic film in a device. Optical filter 500 may depict a top-down view of filters based on structures formed in optical filter 500. Holographic film may be an example of holographic film 220, holographic film 320, or holographic film 420. The depicted pattern may include portions of optical filter 500 that are formed as color filters based on optical frequencies used to form the filters. As shown, optical filter 500 may include red 505, green 510, blue 515, yellow 520, light blue 525, purple 530, black 535, gray 540, and white 545.

In some cases, red 505 may be associated with a first pixel, green 510 with a second pixel, and so on. In some cases, red 505 may be associated with a first set of multiple pixels, green 510 with a second set of multiple pixels, and so on. In some cases, two or more filters (e.g., red 505, green 510, blue 515, etc.) may be associated with an individual pixel, and so on.

The depicted pattern is just one example of a pattern of filters based on the structures formed in a holographic film. The depicted optical filter 500 may be configured with selected dimensions. For example, optical filter 500 may depict a 500 x 500 micron set of filters. Alternatively, optical filter 500 may depict a 1 x 1 micron set of filters, or any set of filters with dimensions between one square micron and 500 square microns.

In some cases, optical filter 500 may be implemented in a display of a device (e.g., mobile device, laptop screen, tablet screen, television screen, etc.). When an image being displayed on the display calls for red, then at least one pixel associated with red 505 may be activated. When the image calls for green, then at least one pixel associated with green 510 may be activated, and so on. In some cases, optical filter 500 may be implemented in a sensor device configured to sense aspects of light. In some cases, red 505 may be associated with detecting red light, green 510 may be associated with detecting green light, and so on.

In some cases, optical filter 500 may be configured with multiple structures based on an optical lithography process described herein. The points of light from the light source that forms structures in optical filter 500 can include one of multiple frequencies (e.g., frequency of red, green, blue, yellow, etc.). For example, a first set of one or more points of light may have a first frequency (e.g., red) that forms one or more structures of filter red 505, a second set of one or more points of light with a second frequency (e.g., green) that forms one or more structures of filter green 510, and so on. The structures formed in optical filter 500 may form a pattern based on the pattern of the points of light (e.g., pattern of frequencies of the light source). The pattern may be repeated (e.g., multiple adjacent instances of optical filter 500, below, above, to the left, and/or to the right of the depicted optical filter 500). In some cases, the pattern may be based on the respective frequencies of light used to form the structures of the holographic film.

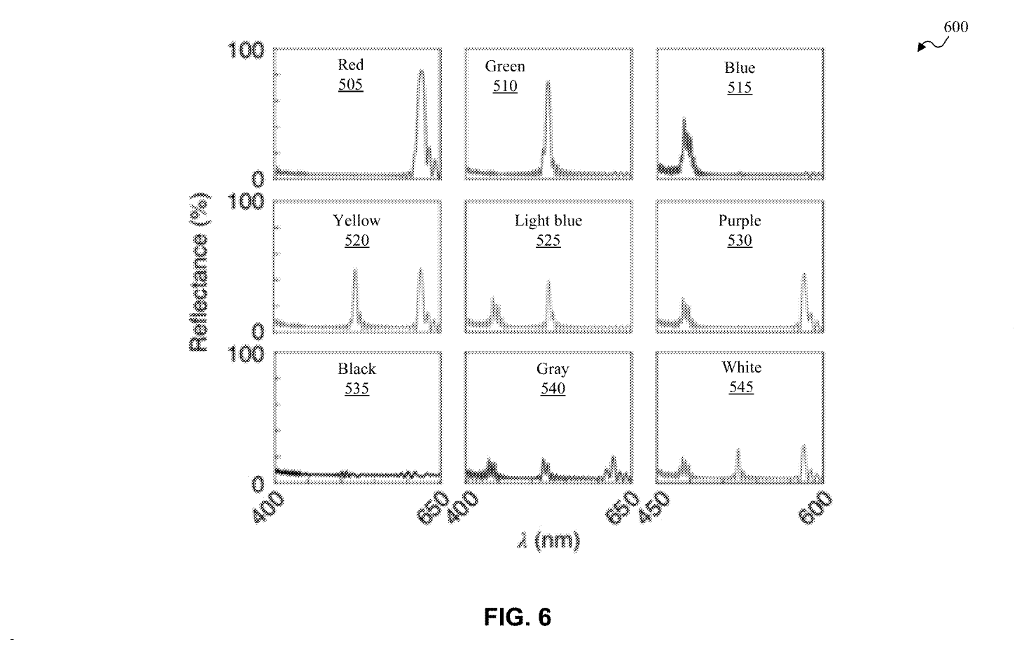

FIG. 6 illustrates an example graph 600 in accordance with one or more implementations as described herein. In some configurations, one or more aspects of graph 600 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.).

In the illustrated example, FIG. 6 depicts graph 600 based on a holographic film (e.g., optical filter 500). As shown, graph 600 illustrates reflectance from 0% to 100% versus wavelength λ from 400 nanometers (nm) to 650 nm for a set of filters of a holographic film. The wavelength range may be a portion of the visible spectrum of light from 380 nm to 750 nm. As shown, graph 600 depicts reflectance for filters red 505, green 510, blue 515, yellow 520, light blue 525, purple 530, black 535, gray 540, and white 545 of optical filter 500.

As shown, the structures formed in holographic film may be formed with relatively thin narrow bands for at least some of the filters. For example, as shown, red 505 and green 510 may be formed with relatively sharp, narrow bands.

Transmission for the depicted structures can be indirectly proportional to reflectance, with minor variations in the proportionality due to absorption. Thus, to some degree, the transmission of the structures of optical filter 500 may be indirectly proportional to the depicted reflectance. Accordingly, as shown, for relatively long wavelengths (e.g., red) the intensity of transmission is higher than relatively short wavelengths (e.g., purple). In some cases, the thickness of the holographic material may be increased based on the trade-off in intensity for shorter wavelengths (e.g., purple).

Based on the optic filters of some systems, the color of a given pixel may shift or may be lost due to the angle. However, based on the systems and methods described herein, the color of a given pixel may retain the color at various viewing angles (e.g., up to 35-degree viewing angle).

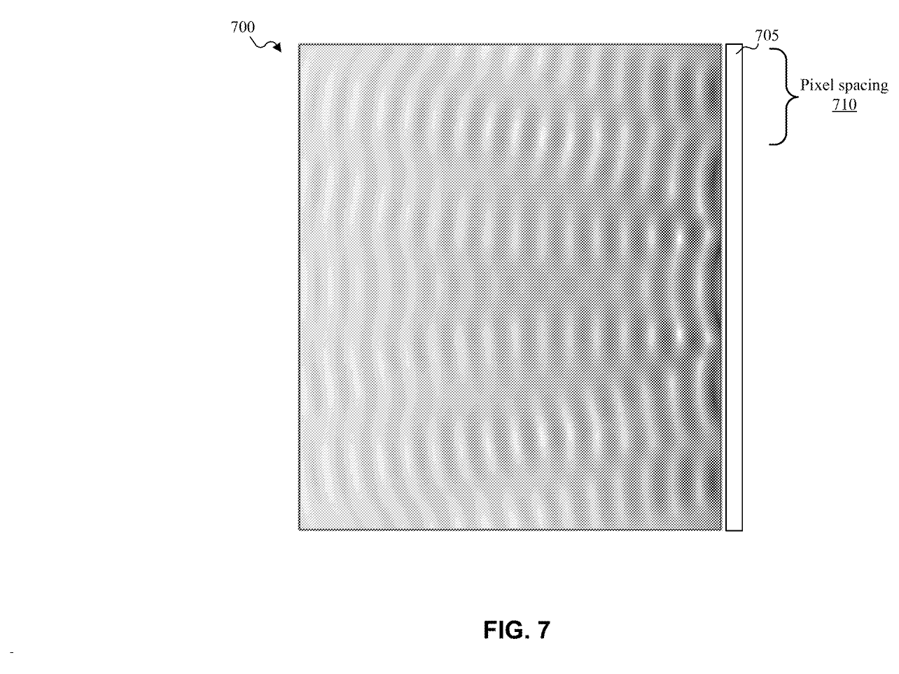

FIG. 7 illustrates an example interference pattern 700 in accordance with one or more implementations as described herein. In some configurations, one or more aspects of interference pattern 700 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.).

In the illustrated example, FIG. 7 depicts interference pattern 700 relative to pixel array 705. Interference pattern 700 may depict a standing wave pattern. Pixel array 705 may include a detector plane. As shown, interference pattern 700 is depicted relative to one example of a pixel spacing (e.g., pixel spacing 710). The depicted pixel spacing 710 may range from 0.2 micrometers to 1 millimeter. Pixel spacing 710 may be produced with light of some wavelength (e.g., 632 nanometers). In some cases, pixel spacing can depend on an aspect of the imaging optics used in the fabrication process (e.g., material used, shape of imaging optics, refractive index, number of imaging optics per pixel, etc.) and the wavelength of the light source, where the wavelength of the light source can control the optical bandwidth of the filter.

Interference pattern 700 may be based on a modeled filter structure formed by holographic on-chip generation of narrow-stopband angle-independent optical filters described herein. In some cases, interference pattern 700 may be achieved by incoherent superposition of spherical waves converging toward different locations in pixel array 705 that interfere (e.g., interfere coherently) with the reflected diverging spherical waves (e.g., to form structures in a holographic film).

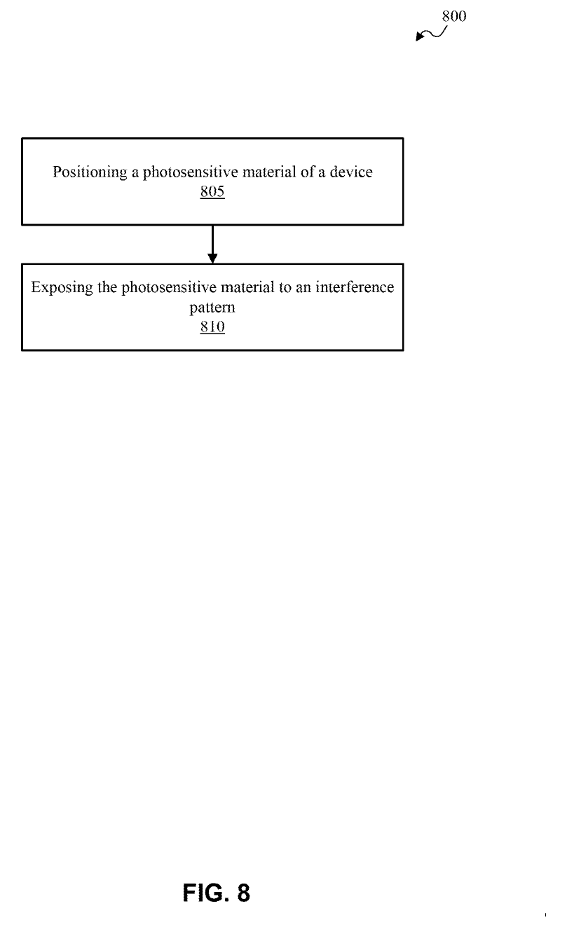

FIG. 8 depicts a flow diagram illustrating an example method 800 associated with the disclosed systems, in accordance with example implementations described herein. In some configurations, one or more aspects of method 800 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.). The depicted method 800 is just one implementation and one or more operations of method 800 may be rearranged, reordered, omitted, and/or otherwise modified such that other implementations are possible and contemplated.

At 805, method 800 may include positioning a photosensitive material of a device. For example, method 800 may include positioning a photosensitive material of a device between a pixel array of the device and an imaging system comprising a light source and a lens.

At 810, method 800 may include exposing the photosensitive material to an interference pattern. For example, method 800 may include exposing the photosensitive material to an interference pattern formed by incident spatially incoherent light from the light source and a reflection of the incident spatially incoherent light. The interference pattern may form filter structures that encode gonio-spectral filtering characteristics matched to a light field and aberration properties of the imaging system.

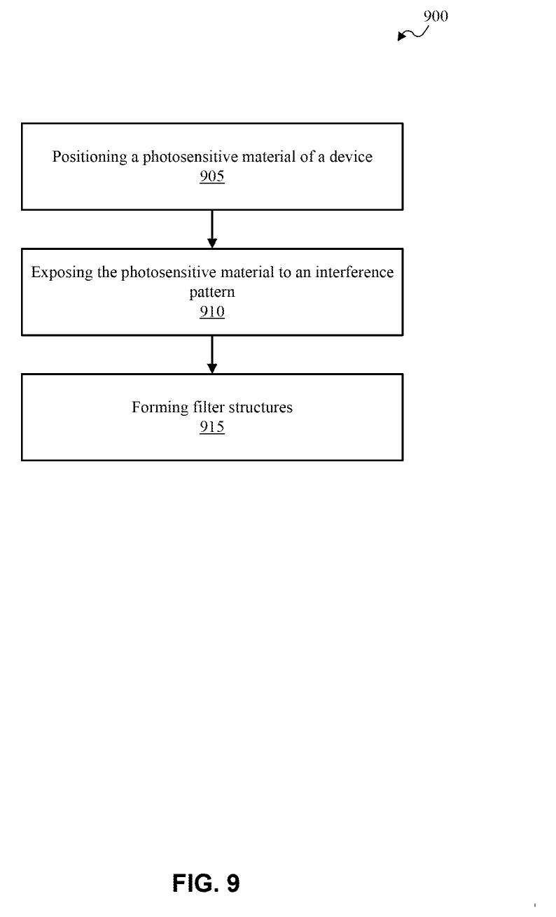

FIG. 9 depicts a flow diagram illustrating an example method 900 associated with the disclosed systems, in accordance with example implementations described herein. In some configurations, one or more aspects of method 900 may be implemented by or in conjunction with a fabrication system configured for the manufacture of semiconductor devices (e.g., detector plane, pixel array, thin films, holographic films) and optical imaging systems (e.g., light sources, imaging optics, lenses, microlenses, etc.). The depicted method 900 is just one implementation and one or more operations of method 900 may be rearranged, reordered, omitted, and/or otherwise modified such that other implementations are possible and contemplated.

At 905, method 900 may include positioning a photosensitive material of a device. For example, method 900 may include positioning a photosensitive material of a device between a pixel array of the device and an imaging system comprising a light source and a lens.

At 910, method 900 may include exposing the photosensitive material to an interference pattern. For example, method 900 may include exposing the photosensitive material to an interference pattern formed by incident spatially incoherent light from the light source and a reflection of the incident spatially incoherent light.

At 915, method 900 may include forming the filter structures in the photosensitive material. For example, method 900 may include forming the filter structures in the photosensitive material by focusing multiple beams of light from the light source on selected areas of the photosensitive material to modify respective refractive indices in the selected areas. The interference pattern may form the filter structures, where the filter structures encode or are encoded with gonio-spectral filtering characteristics that are matched to a light field and aberration properties of the imaging system.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wired and/or wireless communication device such as a switch, router, network interface controller, cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be wireless, wired, mobile, and/or stationary.

As used within this document, the term “communicate” is intended to include transmitting, or receiving, or both transmitting and receiving. Similarly, the bidirectional exchange of data between two devices (both devices transmit and receive during the exchange) may be described as ‘communicating’, when only the functionality of one of those devices is being claimed. The term “communicating” as used herein with respect to wired and/or wireless communication signals includes transmitting the wired and/or wireless communication signals and/or receiving the wired and/or wireless communication signals. For example, a communication unit, which is capable of communicating wired and/or wireless communication signals, may include a wired/wireless transmitter to transmit communication signals to at least one other communication unit, and/or a wired/wireless communication receiver to receive the communication signal from at least one other communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth^{TM}, Global Positioning System (GPS), Wi-Fi, Wi-Max, ZigBee^{TM}, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example, a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA or an ASIC. The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example, a CRT (cathode ray tube) or LCD (liquid crystal display) monitor, for displaying information/data to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, for example, as an information/data server, or that includes a middleware component, for example, an application server, or that includes a front-end component, for example, a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example, a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example, an HTML page) to a client device (for example, for purposes of displaying information/data to and receiving user input from a user interacting with the client device). Information/data generated at the client device (for example, a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples as set forth herein will come to mind to one skilled in the art to which these embodiments pertain to having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation. A number of example implementations have been described. Nevertheless, it will be understood that various modifications may be made without departing from the spirit and scope of the disclosure. Accordingly, additional implementations are within the scope of the following claims.

What is claimed:

1. A method of fabricating a holographic optical filter of a device, the method comprising:
positioning a photosensitive material of the device between a pixel array of the device and an imaging system comprising a light source and a lens; and
exposing the photosensitive material to an interference pattern formed by incident spatially incoherent light from the light source and a reflection of the incident spatially incoherent light, wherein the interference pattern forms filter structures that encode gonio-spectral filtering characteristics matched to a light field and aberration properties of the imaging system.

2. The method of claim 1, wherein:
the photosensitive material is positioned directly on the pixel array, and
the photosensitive material comprises a holographic thin film.

3. The method of claim 1, wherein the photosensitive material is positioned to form a gap between the photosensitive material and the pixel array.

4. The method of claim 3, wherein the gap comprises at least one of a vacuum, a polymer, liquid crystal, a fluid, a gel, glass, air, or any type of gas.

5. The method of claim 1, wherein:
the filter structures are formed in accordance with an expected illumination environment of the device, and
a filter structure of the filter structures is associated with a pixel, a portion of a pixel, or group of pixels in the pixel array.

6. The method of claim 1, further comprising providing a back reflector adjacent to the pixel array to facilitate formation of standing wave interference patterns in the photosensitive material during filter fabrication, wherein a pixel spacing of the pixel array is based on imaging optics of the device and a target wavelength of the light source.

7. The method of claim 1, further comprising forming the filter structures in the photosensitive material by focusing multiple beams of light from the light source on selected areas of the photosensitive material to modify respective refractive indices in the selected areas.

8. The method of claim 1, further comprising tuning a bandwidth of a filter structure of the holographic optical filter based on configuring the interference pattern to control a refractive index contrast in adjacent portions of the photosensitive material.

9. The method of claim 1, wherein the photosensitive material comprises a polymeric film or liquid crystal material, and wherein exposure to the interference pattern modifies a refractive index of respective portions of the photosensitive material to form the filter structures.

10. The method of claim 1, further comprising configuring the holographic optical filter to provide angle-independent spectral filtering for incident light over a field of view of at least 35 degrees.

11. The method of claim 1, further comprising directing spatially incoherent light through the lens configured to project a desired light field onto the photosensitive material, wherein the photosensitive material is exposed to a plurality of spatially incoherent light sources from the light source, the spatially incoherent light sources having spectral characteristics matched to desired filter bands of the respective filter structures to form spatially and spectrally tailored filter structures.

12. A system for fabricating a holographic optical filter of a device, comprising:
a light source and imaging optics of an imaging system; and
a pixel array and a photosensitive material of the device, the photosensitive material positioned between the pixel array and the imaging system, wherein:
filter structures are formed in the photosensitive material by exposure to an interference pattern generated by incident spatially incoherent light from the light source and a reflection of the incident spatially incoherent light off the pixel array, and
the filter structures encode gonio-spectral filtering characteristics matched to a light field and aberration properties of the imaging system.

13. The system of claim 12, wherein the photosensitive material is positioned directly on the pixel array and comprises a holographic thin film.

14. The system of claim 12, wherein the photosensitive material is positioned to form a gap between the photosensitive material and the pixel array.

15. The system of claim 14, wherein the gap comprises at least one of a vacuum, a polymer, liquid crystal, a fluid, a gel, glass, air, or any type of gas.

16. The system of claim 12, wherein the filter structures are formed in accordance with an expected illumination environment of the device, and a filter structure of the filter structures is associated with a pixel, a portion of a pixel, or a group of pixels in the pixel array.

17. The system of claim 12, further comprising a back reflector of the device adjacent to the pixel array, the back reflector configured to facilitate formation of standing wave interference patterns in the photosensitive material during fabrication of the filter structures.

18. A device comprising:
a pixel array; and
a photosensitive material positioned adjacent to the pixel array, wherein:
the photosensitive material includes filter structures that are formed based on the photosensitive material being exposed to an interference pattern generated by incident spatially incoherent light from a light source and a reflection of the incident spatially incoherent light off the pixel array, and
the filter structures encode gonio-spectral filtering characteristics matched to a light field and aberration properties of the light source and imaging optics.

19. The device of claim 18, wherein the photosensitive material is positioned directly on the pixel array and comprises a holographic thin film.

20. The device of claim 18, wherein the photosensitive material is positioned to form a gap between the photosensitive material and the pixel array.
